(19) United States
(12) Patent Application Publication
(10) Pub. No.: US 2026/0139095 A1
(43) Pub. Date: May 21, 2026

(54) PRODUCTION METHOD AND PRODUCTION APPARATUS OF ALIPHATIC POLYESTER-BASED RESIN

(71) Applicant: KANEKA CORPORATION, Osaka (JP)

(72) Inventor: Yusuke Yokono, Hyogo (JP)

(73) Assignee: KANEKA CORPORATION, Osaka (JP)

(21) Appl. No.: 19/451,274

(22) Filed: Jan. 16, 2026

Related U.S. Application Data
(63) Continuation of application No. PCT/JP2024/024258, filed on Jul. 4, 2024.

(30) Foreign Application Priority Data
Jul. 28, 2023 (JP) 2023-123800

(51) Int. Cl. C08G 63/91; B01J 8/08

(52) U.S. Cl. CPC C08G 63/912; B01J 8/082; B01J 8/085; B01J 2208/00628

(57) ABSTRACT

A production method and a production apparatus of a low-molecular weight aliphatic polyester-based resin within a short time and with high accuracy are provided. The method includes mixing an aliphatic polyester-based resin and an alkali in a reaction tank. The mixing includes controlling an amount of addition of the alkali and/or a rate of addition of the alkali based on a molecular weight of the aliphatic polyester-based resin in the reaction tank.

### TECHNICAL FIELD

One or more embodiments of the present invention relate to a method for producing a low-molecular weight aliphatic polyester-based resin. One or more embodiments of the present invention also relate to an apparatus for producing a low-molecular weight aliphatic polyester-based resin.

### BACKGROUND

Aliphatic polyester-based resins are utilized in various applications. In particular, biodegradable resins such as polyhydroxyalkanoic acids (PHAs) have biodegradability and therefore attract attention as environment-conscious resins. Such an aliphatic polyester-based resin usually has a high molecular weight, and therefore a technology for decreasing the molecular weight is known (for example, Patent Literature 1).

### PATENT LITERATURE

Patent Literature 1: International Publication No. WO 2022/113530

While molecular weight adjustment of an aliphatic polyester-based resin (for example, P3HB3HH) is generally performed by a method including decreasing the molecular weight under high-temperature/alkaline conditions, it is necessary for adjusting the molecular weight to a target value to allow a reaction to proceed with the rate of decrease being predicted with analysis of the molecular weight in each case. Although a high pH condition is preferred for shortening the adjustment time, a pH meter is not high in measurement accuracy in a high pH region and the control by pH does not stabilize the rate of decrease in molecular weight and easily causes a substandard event. An adjustment under a relatively low pH condition causes a long time to be taken for the adjustment. In other words, the technology recited in Patent Literature 1 is excellent, but has room for improvement.

### SUMMARY

A production method and a production apparatus of a low-molecular weight aliphatic polyester-based resin within a short time and with high accuracy is provided.

The present inventors have made intensive studies in order to address the above, and as a result, have found that the above can be addressed by controlling the amount of addition of an alkali with, as an index, the molecular weight of an aliphatic polyester-based resin, thereby leading to completion of one or more embodiments of the present invention.

Accordingly, one aspect relates to a method for producing a low-molecular weight aliphatic polyester-based resin, the method including an alkali treatment step of mixing an aliphatic polyester-based resin and an alkali in a reaction tank, wherein the alkali treatment step includes an alkali addition control step of controlling an amount of addition of the alkali and/or a rate of addition of the alkali with, as an index, the molecular weight of the aliphatic polyester-based resin in the reaction tank (hereinafter, referred to as “the present production method”.).

Another aspect relates to an apparatus for producing a low-molecular weight aliphatic polyester-based resin, the apparatus including a reaction tank, an alkali loading section that loads an alkali to the reaction tank, and an alkali treatment section, wherein the alkali treatment section includes a measurement section that measures a molecular weight of an aliphatic polyester-based resin in the reaction tank, and an alkali addition control section that controls an amount of addition of the alkali and/or a rate of addition of the alkali in the alkali loading section with, as an index, the molecular weight of the aliphatic polyester-based resin in the reaction tank, as measured with the measurement section (hereinafter, referred to as “the present production apparatus”.).

According to one or more embodiments of the present invention, it is possible to provide a production method and a production apparatus of a low-molecular weight aliphatic polyester-based resin within a short time and with high accuracy.

### BRIEF DESCRIPTION OF DRAWINGS

FIG. 1 is a schematic view illustrating one example of the present production apparatus.

FIG. 2 is a view illustrating an example relationship between the change in molecular weight of the aliphatic polyester-based resin over time and the rate of addition of the alkali in the present production method.

FIG. 3 is a view illustrating the change in molecular weight of the aliphatic polyester-based resin over time in Examples 1 to 3.

FIG. 4 is a view illustrating the change in pH over time in Examples 1 to 3.

FIG. 5 is a view illustrating the change in rate of addition of the alkali over time in Examples 1 to 3.

FIG. 6(a) is a view illustrating a relationship between the change in molecular weight of the aliphatic polyester-based resin over time and the rate of addition of the alkali in Example 4.

FIG. 6(b) is a view illustrating the change in pH over time in Example 4.

FIG. 7(a) is a view illustrating a relationship between the change in molecular weight of the aliphatic polyester-based resin over time and the rate of addition of the alkali in Example 5.

FIG. 7(b) is a view illustrating the change in pH over time in Example 5.

FIG. 8 is a view illustrating the change in molecular weight of the aliphatic polyester-based resin over time in Comparative Examples 1 to 3.

FIG. 9 is a view illustrating the change in pH over time in Comparative Examples 1 to 3.

FIG. 10 is a view illustrating the change in rate of addition of the alkali over time in Comparative Examples 1 to 3.

### DETAILED DESCRIPTION

One mode for carrying out one or more embodiments of the present invention is described below in detail. Herein, “A to B” representing a numerical value range means “A or more and B or less”, unless particularly noted. All of documents described herein are herein incorporated as Reference Documents.

### 1. Overview of One or More Embodiments of Present Invention

While a decrease in molecular weight of an aliphatic polyester-based resin is generally performed under high-temperature/alkaline conditions as described above, it is here necessary for adjusting the molecular weight of the aliphatic polyester-based resin to a target value to allow a reaction to proceed with the rate of decrease being predicted with analysis of the molecular weight in each case. Although a high pH condition is here preferred for shortening the adjustment time, a pH meter may not be high in measurement accuracy in a high pH region and the control by pH does not stabilize the rate of decrease in molecular weight and easily causes a substandard event, causing the resulting aliphatic polyester-based resin to be low in accuracy of the molecular weight. An adjustment under a relatively low pH condition may cause a long time to be taken for the adjustment.

The present inventors have then made intensive studies in order to address the above, and as a result, have first found that the above may be addressed by controlling the amount of addition of an alkali with, as an index, the molecular weight of an aliphatic polyester-based resin. Specifically, it has been found that a low-molecular weight aliphatic polyester-based resin can be produced within a short time and with high accuracy as a result of supply of an alkali at a relatively large amount of addition and/or a relatively high rate of addition, to a reaction tank including an aliphatic polyester-based resin, at the reaction initial stage, and control of the amount of addition of the alkali and/or the rate of addition of the alkali in stages according to a decrease in molecular weight of the aliphatic polyester-based resin.

Thus, there has not been known any production method and production apparatus each capable of producing a low-molecular weight aliphatic polyester-based resin within a short time and with high accuracy, and such production method and production apparatus are extremely advantageous in the field in which aliphatic polyester-based resins are required to be decreased in molecular weights. Herein, the “molecular weight” may be either the weight average molecular weight or the number average molecular weight, and may be the weight average molecular weight from the viewpoint of having a strong influence on resin characteristics. Herein, the “molecular weight” of an aliphatic polyester-based resin means “weight average molecular weight”, unless particularly noted. Herein, the weight average molecular weight of an aliphatic polyester-based resin means a value measured by a method described in Examples. Hereinafter, the configurations of the present production method and the present production apparatus are described in detail.

### 2. Method for Producing Aliphatic Polyester-Based Resin

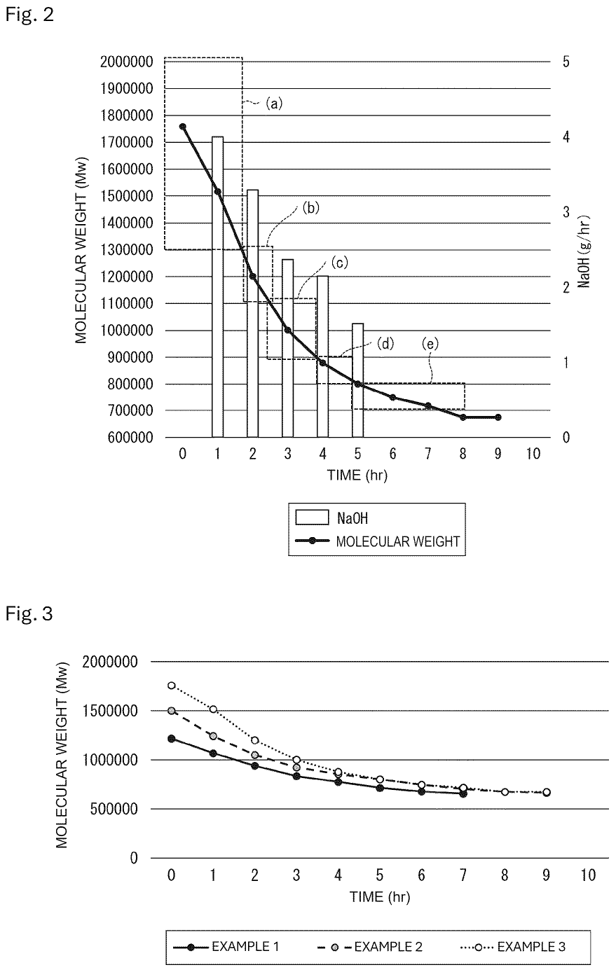

The present production method is described in detail with reference to FIG. 2. The present production method is not here limited to one illustrated in FIG. 2.

In FIG. 2, an object is to allow an aliphatic polyester-based resin having a molecular weight of 1750000 to be decreased in molecular weight to a molecular weight of 700000, for convenience purposes. The amount of addition of the alkali and/or the rate of addition of the alkali are/is set to high value(s) at the reaction initial stage ((a) in FIG. 2) in which the molecular weight is higher than the target molecular weight. The amount of addition of the alkali and/or the rate of addition of the alkali are/is decreased ((b) to (d) in FIG. 2) as the molecular weight of the aliphatic polyester-based resin decreases, with measurement of the molecular weight of the aliphatic polyester-based resin over time. When a value near the target molecular weight is obtained, addition of the alkali is stopped ((e) in FIG. 2), and the pH and/or the temperature are/is reduced to terminate the reaction. The amount of addition of the alkali is thus controlled with the molecular weight of the aliphatic polyester-based resin being measured over time with, as an index, the molecular weight, to produce a low-molecular weight aliphatic polyester-based resin within a short time and with high accuracy. In addition, the alkali is added with the amount of addition thereof being decreased according to a predetermined rule with respect to each target molecular weight in advance, with measurement of the molecular weight, and thus, even if the initial molecular weight differs, the rate of decrease in the molecular weight is reduced toward the end point of the molecular weight and the molecular weight can be easily adjusted to the target molecular weight. Furthermore, as the amount of the alkali is decreased, the amount of the alkali consumed by the reaction exceeds the amount of the alkali added, resulting in a reduction in pH and thus a reduction in reaction rate.

### (Alkali Treatment Step)

The present production method has an alkali treatment step of mixing an aliphatic polyester-based resin and an alkali in a reaction tank. In the present production method, the alkali treatment step includes an alkali addition control step of controlling the amount of addition of the alkali and/or the rate of addition of the alkali with, as an index, the molecular weight of the aliphatic polyester-based resin in the reaction tank. The present production method can be carried out with, as an index, the molecular weight of the aliphatic polyester-based resin in the reaction tank, thereby allowing for the reaction within a short time and with high accuracy as compared with a conventional method for a decrease in molecular weight with the pH as an index.

### (Alkali Addition Control Step)

In one or more embodiments of the present invention, the alkali addition control step may include two or more steps different in amount of addition of the alkali and/or rate of addition of the alkali and the amount of addition of the alkali and/or the rate of addition of the alkali may be decreased as the molecular weight of the aliphatic polyester-based resin in the reaction tank is lower. As described above, the rate of decrease in molecular weight of the aliphatic polyester-based resin in the alkali treatment step is proportional to the amount of the alkali in the reaction system, and the decrease in molecular weight proceeds at a higher rate as the amount of the alkali is larger, whereas the decrease in molecular weight proceeds at a lower rate as the amount of the alkali is smaller. In the alkali addition control step, the amount of addition of the alkali and/or the rate of addition of the alkali can be set to higher value(s) and a relatively large amount of the alkali can be supplied to the reaction system at the reaction initial stage in which the molecular weight is relatively higher than the target molecular weight, thereby rapidly decreasing the molecular weight in the alkali treatment step and shortening a reaction time until an aliphatic polyester-based resin having the target molecular weight is obtained. The amount of addition of the alkali and/or the rate of addition of the alkali are/is decreased, and in some embodiments, are/is decreased in stages, depending on a decrease in molecular weight of the aliphatic polyester-based resin in the reaction tank, thereby enabling the rate of reduction in molecular weight to be controlled to a relatively low rate and facilitating stopping of the reaction at a desired molecular weight, and therefore enabling the aliphatic polyester-based resin having the target molecular weight to be produced with high accuracy.

For example, in a case where the molecular weight of the aliphatic polyester-based resin in the reaction tank is higher than the target molecular weight of the finally obtained low-molecular weight aliphatic polyester-based resin plus 600000, the amount of addition of the alkali and/or the rate of addition of the alkali are/is set to high value(s). In a case where the above target molecular weight is set, the amount of addition of the alkali and/or the rate of addition of the alkali can be set to high value(s) to rapidly decrease the molecular weight and shorten the reaction time until an aliphatic polyester-based resin having the target molecular weight is obtained, at the reaction initial stage in which the molecular weight is relatively higher than the target molecular weight.

The amount of addition of the alkali and/or the rate of addition of the alkali are/is decreased as the molecular weight of the aliphatic polyester-based resin in the reaction tank is lower. Thus, the molecular weight can be brought close to the target molecular weight with the rate of reduction in molecular weight being controlled.

The method for measuring the molecular weight of the aliphatic polyester-based resin in the reaction tank is not particularly limited, and such measurement is performed by, for example, a method described in Examples.

In one or more embodiments of the present invention, the alkali addition control step can be a step which includes step B of adding the alkali in an amount of addition of W_{B} and/or at a rate of addition of S_{B} after step A of adding the alkali in an amount of addition of W_{A} and/or at a rate of addition of S_{A} is carried out, in which the amounts of addition of W_{A} and W_{B} and/or the rates of addition of S_{A} and S_{B} satisfy the following expressions:

$${W}_{A} > {W}_{B}$$

$${S}_{A} > {S}_{B}$$

In one or more embodiments of the present invention, the alkali addition control step may include three or more steps different in amount of addition of the alkali and/or rate of addition of the alkali. When the alkali addition control step includes three or more steps different in amount of addition of the alkali and/or rate of addition of the alkali, the molecular weight can be brought close to the target molecular weight with the alkali being added in stages and the rate of reduction in molecular weight being controlled. The number of steps may be 3 or more, 4 or more, or 5 or more.

The molecular weight of the aliphatic polyester-based resin in the reaction tank, at the initial stage (before molecular weight adjustment), may be, for example, 500000 to 3000000, or 1000000 to 2000000. When the molecular weight falls within the above range, an advantage is that the molecular weight is easily adjusted in a target range within a predetermined time.

The target molecular weight of a low-molecular weight aliphatic polyester-based resin finally obtained by the present production method is not particularly limited as long as it is lower than the initial molecular weight, and may be, for example, 50000 to 1500000, 100000 to 1200000, 150000 to 1000000, 200000 to 800000, or 500000 to 800000. A decrease in molecular weight so that the molecular weight of the aliphatic polyester-based resin falls within the above range has the advantage of enabling the aliphatic polyester-based resin to be applied to various processing methods.

In one or more embodiments of the present invention, the alkali addition control step may decrease the weight average molecular weight of the aliphatic polyester-based resin by 200000 or more, by 300000 or more, by 400000 or more, or by 500000 or more. The upper limit of the weight average molecular weight to be decreased is not particularly limited, and may be, for example, 2950000 or less, 2800000 or less, 2000000 or less, 1500000 or less, 1200000 or less, or 1000000 or less. In other words, a low-molecular weight aliphatic polyester-based resin produced by the present production method may be an aliphatic polyester-based resin (the weight average molecular weight is decreased) having a weight average molecular weight decreased as compared with that of the initial aliphatic polyester-based resin by 200000 to 2950000, an aliphatic polyester-based resin having a weight average molecular weight decreased by 200000 to 2800000, an aliphatic polyester-based resin having a weight average molecular weight decreased by 300000 to 2000000, an aliphatic polyester-based resin having a weight average molecular weight decreased by 400000 to 1500000, an aliphatic polyester-based resin having a weight average molecular weight decreased by 400000 to 1200000, or an aliphatic polyester-based resin having a weight average molecular weight decreased by 500000 to 1000000.

The temperature in the reaction tank in the alkali treatment step may be 40 to 80° C., 42 to 78° C., 45 to 75° C., or 65 to 75° C. When the temperature in the reaction tank in the alkali treatment step falls within the above range, an advantage is that the rate of adjustment of the molecular weight is easily controlled. When the temperature in the reaction tank in the alkali treatment step falls within the above range, such a case is advantageous in terms of cost and time because the amount of the alkali to be used can be reduced and as a result, the number of times of alkali removal in a subsequent centrifugation step can be reduced, and furthermore the reaction rate can also be retained.

The reaction time in the alkali treatment step can be appropriately set depending on the amount of the resin in and the molecular weight of the initial aliphatic polyester-based resin in the reaction tank and the target molecular weight of the finally obtained low-molecular weight aliphatic polyester-based resin. For example, in a case where the molecular weight of the initial aliphatic polyester-based resin in the reaction tank is 1000000 to 3000000 and the target molecular weight of the finally obtained low-molecular weight aliphatic polyester-based resin is 350000, the reaction time in the alkali treatment step may be, for example, 3 to 24 hours, 5 to 20 hours, or 8 to 18 hours. The amount of the resin in the initial aliphatic polyester-based resin in the reaction tank can be arbitrarily set.

The amount of addition of the alkali and/or the rate of addition of the alkali based on the molecular weight of the aliphatic polyester-based resin in the reaction tank in the alkali addition control step are/is here set as follows. For example, in a case where the molecular weight of the aliphatic polyester-based resin in the reaction tank is 1300000 or more, the amount of addition of the alkali and/or the rate of addition of the alkali are/is set so that the amount of the alkali supplied per hour to the reaction tank is 3.5 to 4.5 g/hr (hour), in a case where the molecular weight of the aliphatic polyester-based resin in the reaction tank is 1100000 or more and less than 1300000, the amount of addition of the alkali and/or the rate of addition of the alkali are/is set so that the amount of the alkali supplied per hour to the reaction tank is 2.5 g/hr or more and less than 3.5 g/hr, in a case where the molecular weight of the aliphatic polyester-based resin in the reaction tank is 900000 or more and less than 1100000, the amount of addition of the alkali and/or the rate of addition of the alkali are/is set so that the amount of the alkali supplied per hour to the reaction tank is 1.5 g/hr or more and less than 2.5 g/hr, in a case where the molecular weight of the aliphatic polyester-based resin in the reaction tank is 800000 or more and less than 900000, the amount of addition of the alkali and/or the rate of addition of the alkali are/is set so that the amount of the alkali supplied per hour to the reaction tank is 0.5 g/hr or more and less than 1.5 g/hr, and in a case where the molecular weight of the aliphatic polyester-based resin in the reaction tank is 700000 or more and less than 800000, the amount of addition of the alkali and/or the rate of addition of the alkali are/is set so that the amount of the alkali supplied per hour to the reaction tank is 0.0 g/hr or more (including 0) and less than 0.5 g/hr.

In one or more embodiments of the present invention, the alkali addition control step may include a step of adding 3.5 to 4.5 g/hr of the alkali in a case where the molecular weight of the aliphatic polyester-based resin in the reaction tank is 1300000 or more, a step of adding 2.5 g/hr or more and less than 3.5 g/hr of the alkali in a case where the molecular weight of the aliphatic polyester-based resin in the reaction tank is 1100000 or more and less than 1300000, a step of adding 1.5 g/hr or more and less than 2.5 g/hr of the alkali in a case where the molecular weight of the aliphatic polyester-based resin in the reaction tank is 900000 or more and less than 1100000, a step of adding 0.5 g/hr or more and less than 1.5 g/hr of the alkali in a case where the molecular weight of the aliphatic polyester-based resin in the reaction tank is 800000 or more and less than 900000, and a step of adding 0.0 g/hr or more (including 0) and less than 0.5 g/hr of the alkali in a case where the molecular weight of the aliphatic polyester-based resin in the reaction tank is 700000 or more and less than 800000.

### <Alkali>

In the alkali treatment step in the present production method, the aliphatic polyester-based resin and the alkali are mixed in the reaction tank. The alkali is a basic compound and is not particularly limited, and examples thereof include alkali metal or alkaline-earth metal hydroxides such as sodium hydroxide and potassium hydroxide; metal carbonates such as sodium carbonate and potassium carbonate; and metal phosphates or metal hydrogen phosphates such as sodium phosphate, potassium phosphate, sodium hydrogen phosphate and potassium hydrogen phosphate.

In one or more embodiments of the present invention, the basic alkaline compound may be an alkali metal hydroxide or an alkaline-earth metal hydroxide, or sodium hydroxide. As the basic alkaline compound used in the alkali treatment step, various basic compounds described above may be used singly or in a combination of two or more.

In one or more embodiments of the present invention, the alkali may be an aqueous solution of any of various basic compounds described above from the viewpoint of ease of handling.

### <Aliphatic Polyester-Based Resin>

The aliphatic polyester-based resin in the present production method is not particularly limited and examples thereof include poly(3-hydroxyalkanoate) (hereinafter, also referred to as “P3HA”.), polylactate (PLA), polybutylene succinate (PBS), polybutylene succinate adipate, polybutylene adipate terephthalate, polybutylene succinate terephthalate, and polycaprolactone. In particular, P3HA is preferred from the viewpoint of industrial productivity. The aliphatic polyester-based resins may include a single resin or a combination of two or more resins.

The aliphatic polyester-based resin may include 50% by weight or more, 60% by weight or more, 70% by weight or more, 80% by weight or more, 90% by weight or more, or 95% by weight or more of P3HA in 100% by weight of the aliphatic polyester-based resin. The aliphatic polyester-based resin may include 100% by weight of P3HA in 100% by weight of the aliphatic polyester-based resin.

Hereinafter, there is described in detail with reference to poly(3-hydroxyalkanoate) as one example of the aliphatic polyester-based resin, together with a method for producing a powder including the aliphatic polyester-based resin.

P3HA in the present production method is a polymer having a 3-hydroxyalkanoate unit as a constituent unit (monomer unit). Herein, the “3-hydroxyalkanoate” may also be referred to as “3HA”. P3HA may be a polymer containing a repeating unit represented by the following general formula (1):

$$[ - CHR - {CH}_{2} - CO - O - ] . \qquad ( 1 )$$

In the general formula (1), R denotes an alkyl group represented by CₙH₂ₙ₊₁, and n denotes an integer of 1 to 15. Examples of R include linear or branched alkyl groups such as a methyl group, an ethyl group, a propyl group, an isopropyl group, a butyl group, an isobutyl group, a t-butyl group, a pentyl group, and a hexyl group. n may be 1 to 10, or 1 to 8.

More specifically, examples of P3HA include poly(3-hydroxybutyrate) (P3HB), poly(3-hydroxybutyrate-co-3-hydroxyhexanoate) (P3HB3HH), poly(3-hydroxybutyrate-co-3-hydroxyvalerate) (P3HB3HV), poly(3-hydroxybutyrate-co-4-hydroxybutyrate) (P3HB4HB), poly(3-hydroxybutyrate-co-3-hydroxyoctanoate) (P3HB3HO), poly(3-hydroxybutyrate-co-3-hydroxyoctadecanoate) (P3HB3HOD), poly(3-hydroxybutyrate-co-3-hydroxydecanoate) (P3HB3HD), and poly(3-hydroxybutyrate-co-3-hydroxyvalerate-co-3-hydroxyhexanoate) (P3HB3HV3HH). In particular, P3HB, P3HB3HH, P3HB3HV, and P3HB4HB are preferred because industrial production is easy.

P3HB3HH which is a copolymer of 3-hydroxybutyrate and 3-hydroxyhexanoate is more preferred from the viewpoint that the compositional ratio of the repeating unit can be changed to change the melting point and the degree of crystallization, thereby consequently changing physical properties, for example, Young's modulus and heat resistance, and imparting physical properties between those of polypropylene and those of polyethylene, and that industrial production is easy as described above and P3HB3HH is a useful plastic in terms of physical properties.

More specifically, P3HA is a copolymer having a 3-hydroxybutyrate unit and a comonomer unit, and the ratio of the 3HB unit to the comonomer unit (3HB unit/comonomer unit) in 100 mol % of the entire repeating unit in the copolymer may be 70/30 (mol %/mol %) to 99/1 (mol %/mol %), 75/25 (mol %/mol %) to 97/3 (mol %/mol %), or 80/20 (mol %/mol %) to 95/5 (mol %/mol %).

P3HA having such a ratio of these monomer units can be produced according to a method known by those skilled in the art, for example, the method described in International Publication No. WO 2009/145164. The ratio of these monomer units in P3HA (namely, the above ratio (3HB unit/comonomer unit)) can be determined by a method described in Examples.

In one or more embodiments of the present invention, the method for producing P3HA is not particularly limited, and may be a production method by chemical synthesis or a microbial production method. In particular, a microbial production method is preferred. The microbial method for producing P3HA applied here can be any known method, and may include a culture step.

The method for culturing a microorganism producing P3HA in a culture step is not particularly limited, and, for example, the method described in International Publication No. WO 2019/142717 can be used.

The microorganism producing P3HA is not particularly limited as long as it can intracellularly produce PHA. For example, it is possible to use a microorganism deposited in depositories (for example, IFO and ATCC) of microorganisms and strains isolated from nature, or any variant and transformant which can be prepared therefrom. For example, the first bacterial species producing P3HB as one example of PHA is Bacillus megaterium discovered in 1925, and other examples thereof include natural microorganisms such as Cupriavidus necator (old classification: Alcaligenes eutrophus, Ralstonia eutropha), and Alcaligenes latus. It is known that PHA is accumulated within the cells in these microorganisms.

Examples of the bacterial species producing a copolymer of hydroxybutyrate and any other hydroxyalkanoate, as one example of PHA, include Aeromonas caviae as a P3HB3HV- and P3HB3HH-producing bacterium, and Alcaligenes eutrophus as a P3HB4HB-producing bacterium. In particular, with respect to P3HB3HH, in order to increase productivity of P3HB3HH, more preferred is, for example, an Alcaligenes eutrophus AC32 strain (Alcaligenes eutrophus AC32, FERM BP-6038) (T. Fukui, Y. Doi, J. Bacteriol., 179, p 4821-4830 (1997)) into which genes of a group of PHA synthetases are introduced. A bacterial species, other than the above, may also be a genetically modified microorganism into which various genes associated with PHA synthesis are introduced, depending on PHA to be produced.

### (Alkali Treatment)

The present production method may include alkali treatment (treatment including an operation for adding the alkali) other than the alkali addition control step.

The alkali treatment other than the alkali addition control step can be carried out with, for example, enzyme treatment for decomposing a protein or the like, or centrifugation for removing impurities, and the pH, the temperature, the time, and the like may be controlled depending on the intended use.

### (Pre-Treatment Step)

In one or more embodiments of the present invention, the present production method may further include a pre-treatment step of performing any treatment of the aliphatic polyester-based resin which is before being subjected to the alkali addition control step. The treatment of the aliphatic polyester-based resin performed in the pre-treatment step may be carried out after the culture step and before the alkali addition control step. The pre-treatment step is not particularly limited, any known physical treatment, and/or chemical treatment, and/or biological treatment can be applied, and, for example, the purification method described in International Publication No. WO 2010/067543 may be applied. Examples of more specific treatment of the aliphatic polyester-based resin performed in the pre-treatment step include sterilization treatment, enzyme treatment, surfactant treatment, hydrogen peroxide treatment, and centrifugation.

### (Post-Treatment Step)

In one or more embodiments of the present invention, the present production method may further include a post-treatment step of further performing any treatment of the aliphatic polyester-based resin after the alkali addition control step, after the alkali addition control step. The treatment of the aliphatic polyester-based resin performed in the post-treatment step is not particularly limited, any known physical treatment, and/or chemical treatment, and/or biological treatment can be applied, and, for example, the purification method described in International Publication No. WO 2010/067543 may be applied. Examples of more specific treatment of the aliphatic polyester-based resin performed in the post-treatment step include enzyme treatment, surfactant treatment, hydrogen peroxide treatment, centrifugation, filtration, and drying. The drying method in the post-treatment step is not particularly limited, spray drying, fluidized bed drying, flash drying, rotary drying, vibration drying, band drying, or the like can be applied, and, for example, the drying method described in International Publication No. WO 2018/070492 may be applied.

### 3. Apparatus for Producing Aliphatic Polyester-Based Resin

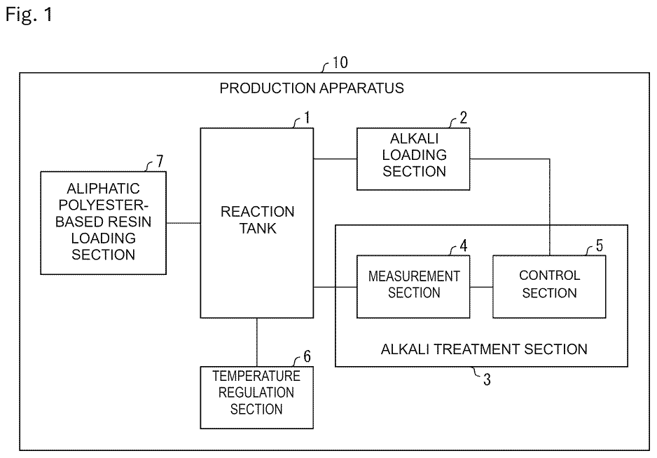

Hereinafter, the present production apparatus is described in detail with reference to FIG. 1. The present production apparatus is not limited to one illustrated in FIG. 1.

The present production apparatus 10 is to carry out the method for producing the aliphatic polyester-based resin, and includes a reaction tank 1, an alkali loading section 2 that loads an alkali to the reaction tank 1, and an alkali treatment section 3. The present production apparatus 10 includes an aliphatic polyester-based resin loading section 7, and the aliphatic polyester-based resin is loaded from the aliphatic polyester-based resin loading section 7 into the reaction tank 1.

The alkali treatment section 3 is to carry out the “alkali treatment step” in the method for producing the aliphatic polyester-based resin, and is configured from a measurement section 4 and a control section 5. The molecular weight of the aliphatic polyester-based resin in the reaction tank 1 is measured with the measurement section 4. The molecular weight of the aliphatic polyester-based resin in the reaction tank, as measured with the measurement section 4, is adopted as an index, to control the amount of addition of the alkali and/or the rate of addition of the alkali in the alkali loading section 2, with the control section 5.

In the alkali treatment section 3, in a case where the molecular weight of the aliphatic polyester-based resin in the reaction tank 1 is higher than the target molecular weight of the finally obtained low-molecular weight aliphatic polyester-based resin plus 600000, the amount of addition of the alkali and/or the rate of addition of the alkali in the alkali loading section 2 are/is set to high value(s). As the molecular weight of a polyester-based resin in the reaction tank 1 is lower, the amount of addition of the alkali and/or the rate of addition of the alkali in the alkali loading section 2 are/is decreased. Thus, an aliphatic polyester-based resin having the target molecular weight is obtained.

The control in the alkali treatment section 3 is made through the control section 5. The control in the alkali treatment section 3 may be performed so that, as the molecular weight of the aliphatic polyester-based resin in the reaction tank 1 is lower, the amount of addition of the alkali and/or the rate of addition of the alkali are/is decreased. Thus, the control can be made so that the molecular weight of the aliphatic polyester-based resin is rapidly decreased at the reaction initial stage and the molecular weight is gradually decreased as it is brought close to the target molecular weight.

The present production apparatus 10 may include a temperature regulation section 6 that may set the temperature in the reaction tank 1 to 40 to 80° C., 42 to 78° C., or 45 to 75° C.

A low-molecular weight aliphatic polyester-based resin obtained by the present production method or the present production apparatus can be utilized in various applications such as paper, films, sheets, tubes, plates, rods, containers (for example, bottle containers), bags, and parts.

The present invention is not limited to each embodiment described above and can be variously modified within the scope recited in the claims, and an embodiment obtained by appropriately combining technical solutions respectively disclosed in different embodiments is also encompassed in the technical scope of the present invention.

Specifically, one or more embodiments of the present invention include the following.
<1> A method for producing a low-molecular weight aliphatic polyester-based resin, the method including an alkali treatment step of mixing an aliphatic polyester-based resin and an alkali in a reaction tank, wherein
   the alkali treatment step includes an alkali addition control step of controlling an amount of addition of the alkali and/or a rate of addition of the alkali with, as an index, a molecular weight of the aliphatic polyester-based resin in the reaction tank.
<2> The production method according to <1>, wherein the alkali addition control step
   includes two or more steps different in amount of addition of the alkali and/or rate of addition of the alkali, and
   allows the amount of addition of the alkali and/or the rate of addition of the alkali to be decreased as the molecular weight of the aliphatic polyester-based resin in the reaction tank is lower.
<3> The production method according to <1> or <2>, wherein the alkali addition control step includes three or more steps different in amount of addition of the alkali and/or rate of addition of the alkali.
<4> The production method according to any of <1> to <3>, wherein a weight average molecular weight of the aliphatic polyester-based resin is decreased by 300000 or more in the alkali addition control step.
<5> The production method according to any of <1> to <4>, further including a pre-treatment step.
<6> The production method according to any of <1> to <5>, wherein a temperature in the reaction tank in the alkali treatment step is 40 to 80° C.
<7> The production method according to any of <1> to <6>, wherein the aliphatic polyester-based resin is poly(3-hydroxyalkanoate).
<8> An apparatus for producing a low-molecular weight aliphatic polyester-based resin, the apparatus including a reaction tank, an alkali loading section that loads an alkali to the reaction tank, and an alkali treatment section, wherein
   the alkali treatment section includes
      a measurement section that measures a molecular weight of an aliphatic polyester-based resin in the reaction tank, and
      an alkali addition control section that controls an amount of addition of the alkali and/or a rate of addition of the alkali in the alkali loading section with, as an index, the molecular weight of the aliphatic polyester-based resin in the reaction tank, as measured with the measurement section.
<9> The production apparatus according to <8>, wherein control is performed in the alkali addition control section so that
   two or more steps different in amount of addition of the alkali and/or rate of addition of the alkali are included, and
   the amount of addition of the alkali and/or the rate of addition of the alkali are/is decreased as the molecular weight of the aliphatic polyester-based resin in the reaction tank is lower.
<10> The production apparatus according to <8> or <9>, wherein control is performed in the alkali addition control section so that three or more steps different in amount of addition of the alkali and/or rate of addition of the alkali are included.
<11> The production apparatus according to any of <8> to <10>, wherein control is performed in the alkali addition control section so that a weight average molecular weight of the aliphatic polyester-based resin is decreased by 300000 or more.
<12> The production apparatus according to any of <8> to <11>, further including a temperature regulation section that sets a temperature in the reaction tank to 40 to 80° C.
<13> The production apparatus according to any of <8> to <12>, wherein the aliphatic polyester-based resin is poly(3-hydroxyalkanoate).

### EXAMPLES

Hereinafter, one or more embodiments of the present invention are described in more detail with reference to Examples, but the present invention is not limited to these Examples. In the present Examples, “P3HA” used here is “P3HB3HH” and “P3HA” can be read as “P3HB3HH”. In the present Examples, the molecular weight means the weight average molecular weight (Mw).

### [Measurement and Evaluation Methods]

Measurement and evaluation in Examples and Comparative Examples were performed by the following methods.

### <Measurement of Molecular Weight>

The molecular weight (weight average molecular weight) of the aliphatic polyester-based resin (P3HA) was measured by the following procedure. Specifically, a culture solution containing the aliphatic polyester-based resin (P3HA) was diluted with distilled water, 1 mL of a slurry having a solid content of 1 mg/l mL was centrifuged, and thereafter the supernatant was removed. Ethanol was added to the resulting precipitate (aliphatic polyester-based resin) to disperse the precipitate in ethanol, and the resultant was centrifuged. The supernatant was removed, the precipitate was dissolved in 1 mL of chloroform, and thereafter an insoluble product was precipitated by centrifugation. This solution was used to measure the molecular weight with a GPC system manufactured by Shimadzu Corporation, equipped with “TSKgel GMHXL 7.8 mm I.D.×30 cm (two columns connected)” (manufactured by Tosoh Corporation) in conditions of a column temperature of 40° C., a flow rate of 1.0 mL/min, a sample concentration of 1 mg/mL, an amount of injection of the dissolved liquid of 100 μL, and an analysis time of 30 minutes with chloroform as a mobile phase. The molecular weight standard sample used here was Shodex K-804 (polystyrene gel) manufactured by Showa Denko K.K.

### Example 1

### (Culture Step)

Ralstonia eutropha described in International Publication No. WO 2019/142717 was cultured by the method described in paragraphs to of the same literature, to obtain a bacterial cell culture solution including bacterial cells containing P3HA. The compositional ratio of the repeating units of P3HA (compositional ratio of 3-hydroxybutyrate unit/3-hydroxyhexanoate unit) was 89.0/11.0 (mol/mol) as it was measured.

### (Pre-Treatment Step)

The bacterial cell culture solution obtained as described above was subjected to heating/stirring treatment at an inner temperature of 70° C. for 4 hours to perform sterilization treatment. Five kg of a culture solution in which the slurry concentration was adjusted so that the solid content concentration of P3HA was about 20% was adjusted to 50° C. After enzyme treatment was carried out, 55 g of an aqueous 30% sodium hydroxide solution was added in alkali treatment for adjustment of the pH to 12, and thereafter the molecular weight of P3HA in the culture solution was measured and thus was 1220000.

### (Alkali Addition Control Step: Target Molecular Weight 550000 to 700000)

Addition to 5 kg of the pre-treated culture solution obtained above (pre-treated culture solution) was started at an inner temperature in the reaction tank of 50° C. and in an amount of charging of 30% sodium hydroxide of 4 g/hr.

Thirty percent sodium hydroxide was continuously added with the molecular weight of P3HA being measured over time. When the molecular weight of P3HA reached 1030000, the amount of charging of 30% sodium hydroxide was changed to 2 g/hr, when the molecular weight reached 840000, the amount was changed to 1 g/hr, when the molecular weight reached 780000, the amount was changed to 0 g/hr (addition was stopped), and when the molecular weight reached 680000, cooling was started (the flow rate of addition (amount of charging) was decreased in stages, depending on the measurement value, to perform adjustment to the target molecular weight. When the target molecular weight was achieved, cooling was made to terminate the reaction.). The results are illustrated in FIG. 3. The molecular weight of P3HA obtained was 650000.

### Example 2

### (Culture Step)

A bacterial cell culture solution was prepared by the same method as in Example 1.

### (Pre-Treatment Step)

The bacterial cell culture solution obtained as described above was subjected to heating/stirring treatment at an inner temperature of 70° C. for 8 hours to perform sterilization treatment. Five kg of a culture solution in which the slurry concentration was adjusted so that the solid content concentration of P3HA was about 20% was adjusted to 50° C. After enzyme treatment was carried out, 51 g of an aqueous 30% sodium hydroxide solution was added in alkali treatment for adjustment of the pH to 12, and thereafter the molecular weight of P3HA in the culture solution was measured and thus was 1500000.

### (Alkali Addition Control Step: Target Molecular Weight 550000 to 700000)

The alkali treatment of P3HA was performed by the same method as in Example 1. Addition of 30% sodium hydroxide was started in an amount of charging of 4 g/hr, and 30% sodium hydroxide was continuously added with the molecular weight of P3HA being measured over time. When the molecular weight of P3HA reached 1240000, the amount of charging of 30% sodium hydroxide was changed to 3 g/hr, when the molecular weight reached 1050000, the amount was changed to 2 g/hr, when the molecular weight reached 850000, the amount was changed to 1 g/hr, when the molecular weight reached 750000, the amount was changed to 0 g/hr (addition was stopped), and when the molecular weight reached 670000, cooling was started. The results are illustrated in FIG. 3. The molecular weight of P3HA obtained was 660000.

### Example 3

### (Culture Step)

A bacterial cell culture solution was prepared by the same method as in Example 1.

### (Pre-Treatment Step)

The bacterial cell culture solution obtained as described above was subjected to heating/stirring treatment at an inner temperature of 70° C. for 8 hours to perform sterilization treatment. Five kg of a culture solution in which the slurry concentration was adjusted so that the solid content concentration of P3HA was about 20% was adjusted to 50° C. After enzyme treatment was carried out, 58 g of an aqueous 30% sodium hydroxide solution was added in alkali treatment for adjustment of the pH to 12, and thereafter the molecular weight of P3HA in the culture solution was measured and thus was 1760000.

### (Alkali Addition Control Step: Target Molecular Weight 550000 to 700000)

The alkali treatment of P3HA was performed by the same method as in Example 1. Addition of 30% sodium hydroxide was started in an amount of charging of 4 g/hr, and 30% sodium hydroxide was continuously added with the molecular weight of P3HA being measured over time. When the molecular weight of P3HA reached 1200000, the amount of charging of 30% sodium hydroxide was changed to 3 g/hr, when the molecular weight reached 1000000, the amount was changed to 2 g/hr, when the molecular weight reached 880000, the amount was changed to 1 g/hr, when the molecular weight reached 750000, the amount was changed to 0 g/hr (addition was stopped), and when the molecular weight reached 680000, cooling was started. The results are illustrated in FIG. 3. The molecular weight of P3HA obtained was 680000.

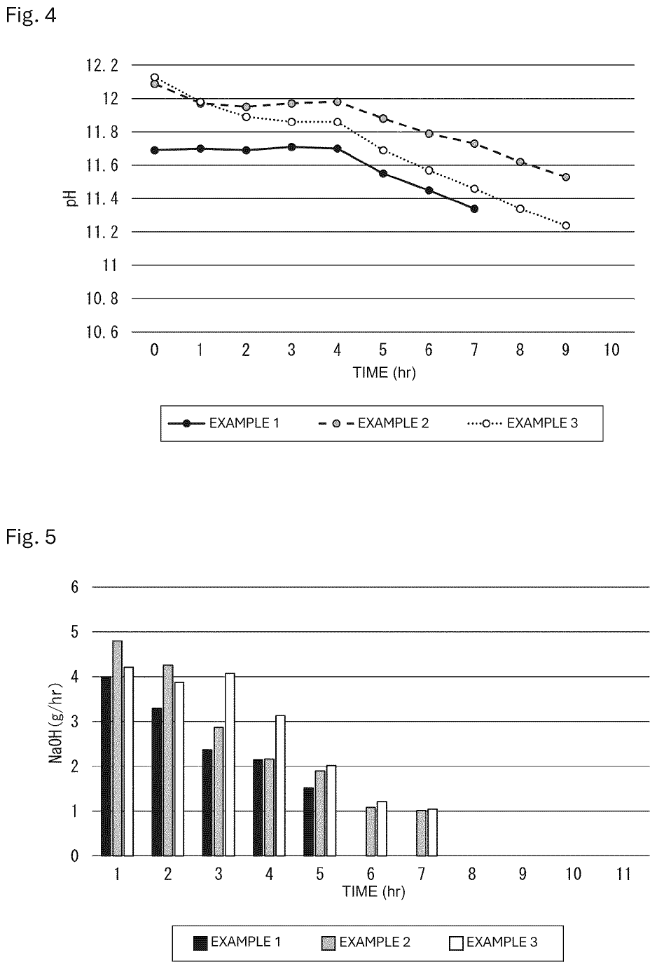

The concept of addition of the alkali in each of Examples 1 to 3 is shown in Table 1 and FIG. 2. The pH trend in each of Examples 1 to 3 is illustrated in FIG. 4. Furthermore, the trend of the amount of addition of the alkali in each of Examples 1 to 3 is illustrated in FIG. 5.

TABLE 1

| | Analysis value | |
|---|---|---|
| | of molecular weight | g/hr |
| (a) | 1300000 or more | 4 |
| (b) | 1100000 to 1300000 | 3 |
| (c) | 900000 to 1100000 | 2 |
| (d) | 800000 to 900000 | 1 |
| (e) | 700000 to 800000 | 0 |
| | 700000 | Start of |
| | | cooling |

### Example 4

### (Culture Step)

A bacterial cell culture solution was prepared by the same method as in Example 1.

### (Pre-Treatment Step)

The bacterial cell culture solution obtained as described above was subjected to heating/stirring treatment at an inner temperature of 70° C. for 4 hours to perform sterilization treatment. Five kg of a culture solution in which the slurry concentration was adjusted so that the solid content concentration of P3HA was about 20% was adjusted to 70° C. After 22 g of an aqueous 30% sodium hydroxide solution was added in alkali treatment for adjustment of the pH to 10, the molecular weight of P3HA in the culture solution was measured and thus was 2000000.

### (Alkali Addition Control Step: Target Molecular Weight 550000 to 700000)

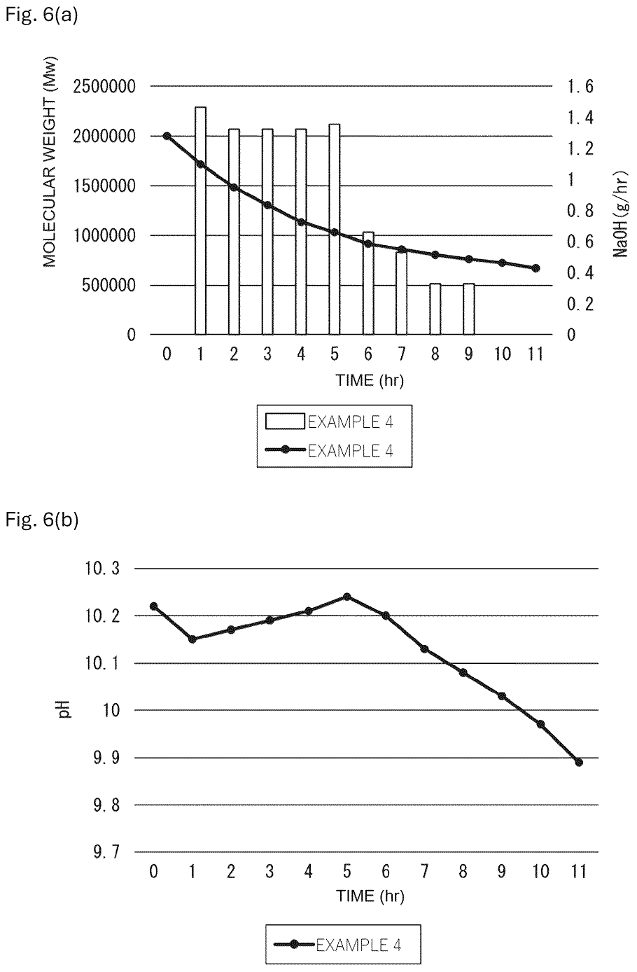

The alkali treatment of P3HA was performed by the same method as in Example 1, provided that different pre-treatment step, set temperature and flow rate of the alkali were adopted. Addition of 30% sodium hydroxide was started in an amount of charging of 1.3 g/hr, and 30% sodium hydroxide was continuously added with the molecular weight of P3HA being measured over time. When the molecular weight of P3HA reached 1140000, the amount of charging of 30% sodium hydroxide was changed to 0.7 g/hr, when the molecular weight reached 1030000, the amount was changed to 0.5 g/hr, when the molecular weight reached 920000, the amount was changed to 0.3 g/hr, when the molecular weight reached 810000, the amount was changed to 0 g/hr (addition was stopped), and when the molecular weight reached 720000, cooling was started. The results are illustrated in FIGS. 6(a) and (b). The molecular weight of P3HA obtained was 670000.

### Example 5

### (Culture Step)

A bacterial cell culture solution was prepared by the same method as in Example 1.

### (Pre-Treatment Step)

The bacterial cell culture solution obtained as described above was subjected to heating/stirring treatment at an inner temperature of 70° C. for 4 hours to perform sterilization treatment. Five kg of a culture solution in which the slurry concentration was adjusted so that the solid content concentration of P3HA was about 20% was adjusted to 70° C. After 45 g of an aqueous 30% sodium hydroxide solution was added in alkali treatment for adjustment of the pH to 11, the molecular weight of P3HA in the culture solution was measured and thus was 1500000.

### (Alkali Addition Control Step: Target Molecular Weight 120000 to 270000)

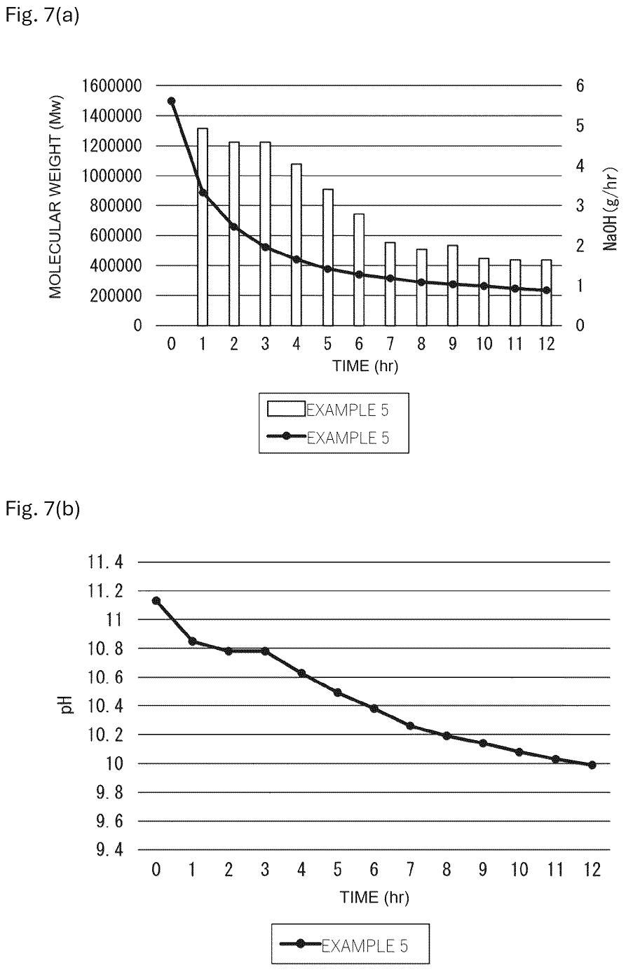

The alkali treatment of P3HA was performed by the same method as in Example 1, provided that different pre-treatment step, set temperature and flow rate of the alkali were adopted. Specifically, addition of 30% sodium hydroxide was started in an amount of charging of 5 g/hr, and 30% sodium hydroxide was continuously added with the molecular weight of P3HA being measured over time. When the molecular weight of P3HA reached 660000, the amount of charging of 30% sodium hydroxide was changed to 4 g/hr, when the molecular weight reached 520000, the amount was changed to 3.3 g/hr, when the molecular weight reached 440000, the amount was changed to 2.7 g/hr, when the molecular weight reached 380000, the amount was changed to 2 g/hr, when the molecular weight reached 290000, the amount was changed to 1.5 g/hr, and when the molecular weight reached 250000, cooling was started. The results are illustrated in FIGS. 7(a) and (b). The molecular weight of P3HA obtained was 240000.

### Comparative Example 1

### (Culture Step)

A bacterial cell culture solution was prepared by the same method as in Example 1.

### (Pre-Treatment Step)

The bacterial cell culture solution obtained as described above was subjected to heating/stirring treatment at an inner temperature of 70° C. for 4 hours to perform sterilization treatment. After furthermore enzyme treatment was carried out, 5 kg of a culture solution in which the slurry concentration was adjusted so that the solid content concentration of P3HA was about 20% was adjusted to 50° C. After 51 g of an aqueous 30% sodium hydroxide solution was added in alkali treatment for adjustment of the pH to 11.5, the molecular weight of P3HA in the culture solution was measured and thus was 1650000.

### (Alkali Treatment Step: Target Molecular Weight 550000 to 700000)

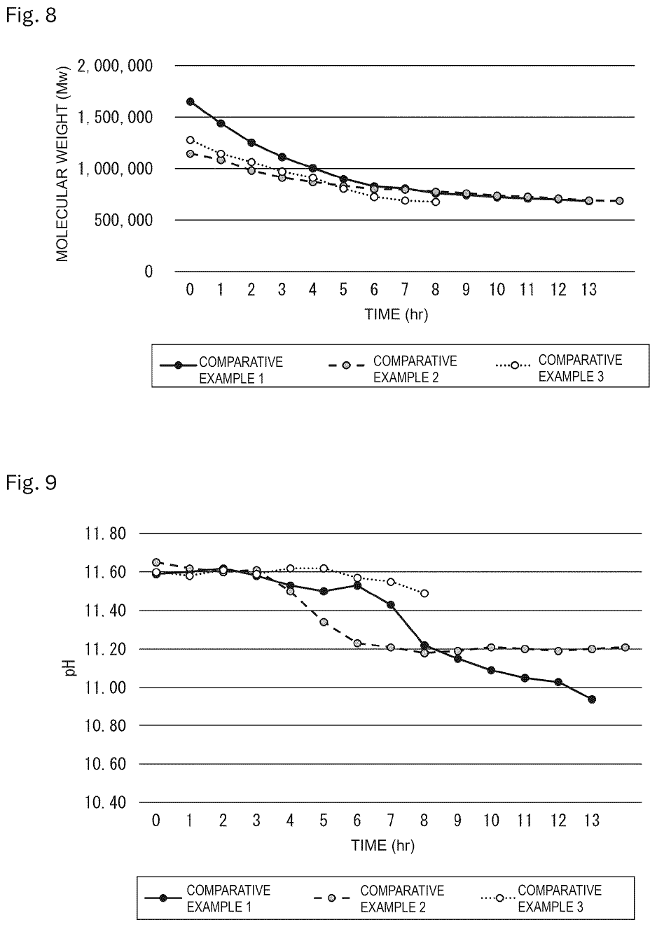

The inner temperature and the pH of a slurry of the inactivated culture solution obtained above (inactivated culture solution) were adjusted respectively to 50±3° C. and 11.5. The pH of the slurry was kept at 11.5±0.2 by continuously adding 30% sodium hydroxide. When the molecular weight reached 1000000 with the molecular weight of P3HA being measured over time, addition of 30% sodium hydroxide was temporarily stopped, and, after a decrease in pH, addition of 30% sodium hydroxide was restarted to keep a pH of 11.2±0.2. When the molecular weight reached 700000 (at a lapse of 12 hours from the start of the alkali treatment step), the temperature was lowered to terminate the reaction. The results are illustrated in FIG. 8.

### Comparative Example 2

### (Culture Step)

A bacterial cell culture solution was prepared by the same method as in Example 1.

### (Pre-Treatment Step)

The bacterial cell culture solution obtained as described above was subjected to heating/stirring treatment at an inner temperature of 70° C. for 4 hours to perform sterilization treatment. After enzyme treatment was carried out, 5 kg of a culture solution in which the slurry concentration was adjusted so that the solid content concentration of P3HA was about 20% was adjusted to 50° C. After 49 g of an aqueous 30% sodium hydroxide solution was added in alkali treatment for adjustment of the pH to 11.5, the molecular weight of P3HA in the culture solution was measured and thus was 1140000.

### (Alkali Treatment Step: Target Molecular Weight 550000 to 700000)

The molecular weight of P3HA was adjusted by the same method as in Comparative Example 1. The results are illustrated in FIG. 8.

### Comparative Example 3

### (Culture Step)

A bacterial cell culture solution was prepared by the same method as in Example 1.

### (Pre-Treatment Step)

The bacterial cell culture solution obtained as described above was subjected to heating/stirring treatment at an inner temperature of 70° C. for 4 hours to perform sterilization treatment. After enzyme treatment was carried out, 5 kg of a culture solution in which the slurry concentration was adjusted so that the solid content concentration of P3HA was about 20% was adjusted to 50° C. After 50 g of an aqueous 30% sodium hydroxide solution was added in alkali treatment for adjustment of the pH to 11.5, the molecular weight of P3HA in the culture solution was measured and thus was 1280000.

### (Alkali Treatment Step: Target Molecular Weight 550000 to 700000)

The molecular weight of P3HA was adjusted by the same method as in Comparative Example 1. The results are illustrated in FIG. 8.

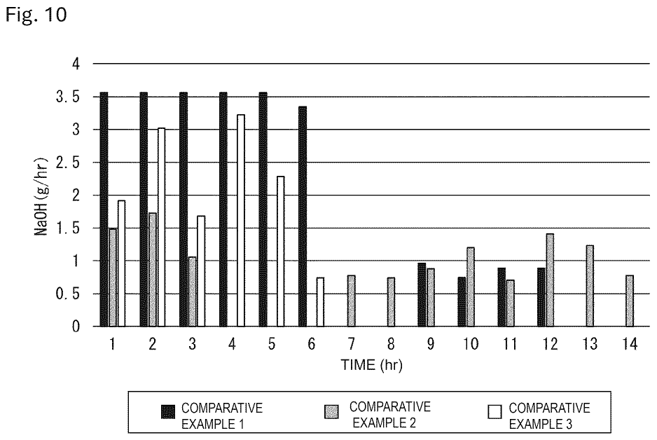

The pH trend in each of Comparative Examples 1 to 3 is illustrated in FIG. 9. The trend of the amount of addition of the alkali in each of Comparative Examples 1 to 3 is illustrated in FIG. 10.

### Results

In Examples 1 to 5, the molecular weight of the aliphatic polyester-based resin was rapidly reduced at the reaction initial stage, and as the molecular weight of the aliphatic polyester-based resin in the reaction tank was lower, the molecular weight could be brought close to the target molecular weight with the rate of reduction in molecular weight being controlled. It was found according to comparison of Examples 1 to 3 that, even if the initial molecular weights were 1220000, 1500000 and 1760000 and were different, the alkali was added according to the same rule to result in a significant decrease of 100000/hr or more at the reaction initial stage, enable the decrease in molecular weight in the vicinity of the reaction end point to be controlled to about 0 to 30000, and provide PHA having the target molecular weight with high accuracy. It was further found according to comparison of Examples 4 to 5 that, even if the temperature condition, the pre-treatment condition (presence or absence of enzyme treatment), and the target molecular weight were changed, PHA having the target molecular weight was obtained with high accuracy.

In this regard, in Comparative Examples 1 to 3, the index was only the pH, and therefore during the latter half of the reaction, the time for molecular weight adjustment was elongated if adjustment with high accuracy was tried, and the molecular weight departed from the target molecular weight if the time for molecular weight adjustment was tried to be shortened.

More specifically, in Comparative Examples 1 to 3, the amount of addition of the alkali was significantly varied regardless of adjustment of the molecular weight in the same pH condition. In other words, control based on the pH resulted in the difference in amount of addition of NaOH. The present inventors have presumed the reason why control of a decrease in molecular weight based on the pH is not desired, as follows:
A decrease in molecular weight is due to a reaction of COOR and OH in a resin, and therefore the pH, although can be adopted as an index of the reaction rate, is not suitable for control of a decrease in molecular weight.
The molecular weight is continuously decreased for a period until the pH is decreased, and therefore a decrease in molecular weight for a period until the pH is decreased cannot be predicted.
About 2 hr is taken for analysis of the molecular weight, and therefore adjustment to a target value cannot be achieved in a state where prediction cannot be made.
The reaction time is varied (8 to 14 hours (average 12 hrs) in Comparative Examples).
Even if the temperature, the pH, and the amount of the resin are respectively made uniform, the rate of decrease in the molecular weight cannot be replicated (the reaction rate cannot be calculated by the general expression or the like of the reaction rate.).
A key factor for adjustment is mainly a gut feeling based on prediction of the rate of decrease in the molecular weight.

From the foregoing, it has been indicated that a low-molecular weight aliphatic polyester-based resin can be produced within a short time and with high accuracy in one or more embodiments of the present invention.

### INDUSTRIAL APPLICABILITY

According to one or more embodiments of the present invention, a low-molecular weight aliphatic polyester-based resin can be produced within a short time and with high accuracy. Accordingly, one or more embodiments of the present invention can be suitably utilized in the fields of agricultural industry, fishery industry, forestry industry, horticulture, medical science, sanitary articles, apparel, non-apparel, packaging, automobiles, building materials, and others.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

### REFERENCE SIGNS LIST

1 reaction tank
2 alkali loading section
3 alkali treatment section
4 measurement section
5 control section
6 temperature regulation section
7 aliphatic polyester-based resin loading section
10 production apparatus

1. A production method for a low-molecular weight aliphatic polyester-based resin, comprising mixing an aliphatic polyester-based resin and an alkali in a reaction tank,
wherein the mixing comprises controlling an amount of addition of the alkali and/or a rate of addition of the alkali based on a molecular weight of the aliphatic polyester-based resin in the reaction tank, and
wherein the aliphatic polyester-based resin is poly(3-hydroxyalkanoate).

2. The production method according to claim 1, wherein the controlling comprises:
performing two or more steps that differ in an amount of addition of the alkali and/or a rate of addition of the alkali, the amount of addition of the alkali and/or the rate of addition of the alkali being lower as the molecular weight of the aliphatic polyester-based resin in the reaction tank is lower.

3. The production method according to claim 1, wherein the controlling comprises performing three or more steps that differ in an amount of addition of the alkali and/or a rate of addition of the alkali.

4. The production method according to claim 1, wherein a weight average molecular weight of the aliphatic polyester-based resin is decreased by 300,000 or more in the controlling.

5. The production method according to claim 1, further comprising pre-treating the aliphatic polyester-based resin prior to the mixing.

6. The production method according to claim 1, wherein a temperature in the reaction tank is maintained from 40 to 80° C. during the controlling.

7. An apparatus for producing a low-molecular weight aliphatic polyester-based resin, comprising a reaction tank, an alkali loading section that loads an alkali to the reaction tank, and an alkali treatment section, wherein the alkali treatment section comprises:
a measurement section that measures a molecular weight of an aliphatic polyester-based resin in the reaction tank, and
an alkali addition control section that controls an amount of addition of the alkali and/or a rate of addition of the alkali in the alkali loading section based on the molecular weight of the aliphatic polyester-based resin in the reaction tank, as measured by the measurement section,
wherein the aliphatic polyester-based resin is poly(3-hydroxyalkanoate).

8. The apparatus according to claim 7, wherein the alkali addition control section is configured to perform two or more steps that differ in an amount of addition of the alkali and/or a rate of addition of the alkali, the amount of addition of the alkali and/or the rate of addition of the alkali being lower as the molecular weight of the aliphatic polyester-based resin in the reaction tank is lower.

9. The apparatus according to claim 7, wherein the alkali addition control section is configured to perform three or more steps that differ in an amount of addition of the alkali and/or a rate of addition of the alkali.

10. The apparatus according to claim 7, wherein the alkali addition control section is configured such that a weight average molecular weight of the aliphatic polyester-based resin is decreased by 300,000 or more.

11. The apparatus according to claim 7, further comprising a temperature regulation section that sets a temperature in the reaction tank from 40 to 80° C.

12. The production method according to claim 2, wherein the controlling comprises performing three or more steps that differ in an amount of addition of the alkali and/or a rate of addition of the alkali.

13. The production method according to claim 2, wherein a weight average molecular weight of the aliphatic polyester-based resin is decreased by 300,000 or more in the controlling.

14. The production method according to claim 2, further comprising pre-treating the aliphatic polyester-based resin prior to the mixing.

15. The production method according to claim 2, wherein a temperature in the reaction tank is maintained from 40 to 80° C. during the controlling.

16. The apparatus according to claim 8, wherein the alkali addition control section is configured to perform three or more steps that differ in an amount of addition of the alkali and/or a rate of addition of the alkali.
